(19) United States
(12) Patent Application Publication
(10) Pub. No.: US 2012/0273539 A1
(43) Pub. Date: Nov. 1, 2012

(54) SUPPORT STRUCTURE AND METHOD OF MANUFACTURING THE SAME

(75) Inventor: Jon T. Carter, Farmington, MI (US)

(73) Assignee: GM GLOBAL TECHNOLOGY OPERATIONS LLC, Detroit, MI (US)

(21) Appl. No.: 13/096,067

(22) Filed: Apr. 28, 2011

(51) Int. Cl. B60R 11/00; B22D 19/00

(52) U.S. Cl. 224/545; 164/98

(57) ABSTRACT

A tubular support member includes a plurality of undulations extending along a longitudinal axis of the tubular support member and angularly spaced about the longitudinal axis. The undulations form a plurality of alternating peaks and valleys in the tubular support member. A cast member is overcast from a molten metal onto and around the undulations in interlocking engagement with the undulations, and extends from the tubular support member to a cantilevered distal end.

### TECHNICAL FIELD

The invention generally relates to a support structure for use in a vehicle, and a method of manufacturing the support structure.

### BACKGROUND

Motor vehicles, including but not limited to passenger cars and light trucks, may include several different support structures for supporting various components of the vehicle. An example of such a support structure is an instrument panel support beam. These support structures may be manufactured completely from a metal, and include a primary tubular support to which various different support plates and/or mounts are welded. Alternatively, in order to reduce weight of the vehicle, the various different support plates and/or mounts may be overcast onto the tubular support from a lightweight material. For example, the tubular support may include a simple round cylindrical metal tube, to which the various different support plates and/or mounts are overcast onto the cylindrical tube from magnesium, or some other lightweight metal, thereby forming a support structure.

### SUMMARY

A method of manufacturing a support structure is provided. The method includes forming a tubular support member to define a plurality of undulations. The undulations extend longitudinally along a longitudinal axis of the tubular support member, and are angularly spaced about the longitudinal axis. A cast member is then overcast around an outer periphery of the tubular support member such that the cast member is overcast in interlocking engagement with the plurality of undulations in the tubular support member.

A support structure is also provided. The support structure includes a tubular support member. The tubular support member includes a plurality of undulations that extend along a longitudinal axis of the tubular support member. The undulations are angularly spaced about the longitudinal axis. The tubular support member is formed from a metal. A cast member is cast about an outer periphery of the tubular support member in interlocking engagement with the plurality of undulations. The cast member extends transversely away from the longitudinal axis to a distal end. The cast member is overcast onto the tubular support member from a molten metal.

Accordingly, the position of the cast member is rotationally fixed relative to the tubular support member about the longitudinal axis because the cast member is cast around the undulations in interlocking engagement. Furthermore, the undulations increase the rigidity of the tubular support member against localized collapse of the tubular support member during the overcasting process, thereby preventing localized depressions or indentations in the tubular support member and/or the cast member. Additionally, the undulations allow for the tubular support member to flex radially inward as the cast member cools during the overcasting process, thereby preventing hot tearing of the cast member, and reducing fatigue stresses caused by thermal cycling.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a support structure manufactured in accordance with the method described herein.

FIG. 2 is a schematic cross sectional view of the support structure.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

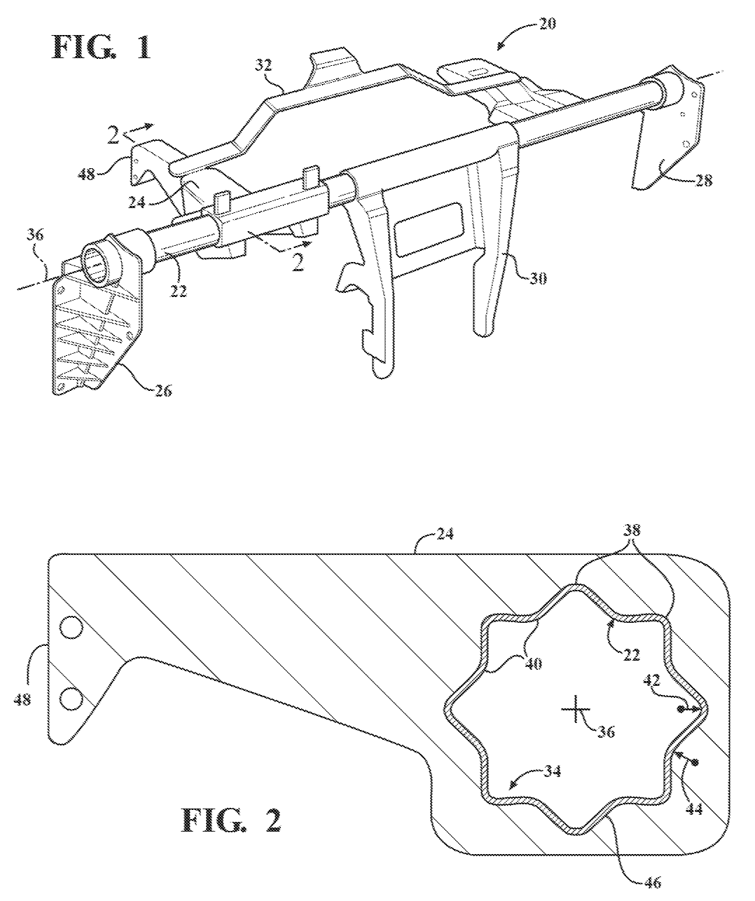

Referring to the Figures, wherein like numerals indicate like parts throughout the several views, a support structure is generally shown at 20. The support structure 20 may include any size, shape, and/or configuration suitable for multiple different uses. For example and as shown in FIG. 1, the support structure 20 includes an instrument panel support beam for a vehicle. However, it should be appreciated that the support structure 20 is not limited to the instrument panel support beam shown.

Referring to FIGS. 1 and 2, the support structure 20 includes a tubular support member 22 and at least one cast member 24 overcast onto the tubular support member 22. The support structure 20 may include any number of cast members 24 suitable for the specific use of the support structure 20. For example and as shown in FIG. 1, the cast member 24 may include any one of or all of a first end mount 26, a second end mount 28, a vertical center support 30 and a horizontal center support 32.

The support structure 20 and a method of manufacturing the support structure 20 are described herein. The method includes forming the tubular support member 22. The tubular support member 22 is formed to define a plurality of undulations 34, shown in FIG. 2. The undulations 34 extend longitudinally along a longitudinal axis 36 of the tubular support member 22, and are angularly spaced about the longitudinal axis 36.

Referring to FIG. 2, the tubular support member 22 defines a cross section perpendicular to the longitudinal axis 36 that includes a plurality of peaks 38 alternating with a plurality of valleys 40. The alternating peaks 38 and valleys 40 combine to form the undulations 34 in the tubular support member 22. The tubular support member 22 includes a pre-defined number of peaks 38, and a pre-defined number of valleys 40. The number of peaks 38 is equal to the number of valleys 40. The number of peaks 38 and the number of valleys 40 are each at least equal to or greater than three (3). Preferably, the number of peaks 38 and the number of valleys 40 are each between the range of six (6) and ten (10). As shown in FIG. 2, the number of peaks 38 and the number of valleys 40 is equal to eight (8). However, it should be appreciated that the tubular support member 22 may include any suitable number of peaks 38 and valleys 40 to define any suitable number of undulations 34.

The peaks 38 and the valleys 40 may each define a radius. The radius 42 of the peaks 38 is preferably, but not necessarily, equal to the radius 44 of the valleys 40. Preferably, the radii 42 of the peaks 38 is between the range of three millimeters (3.0 mm) and ten millimeters (10 mm), and the radii 44 of the valleys 40 is between the range of five millimeters (5 mm) and twenty millimeters (20 mm). However, it should be appreciated that the radii 42 of the peaks 38 and the radii 44 of the valleys 40 may differ from the preferred range described above.

The tubular support member 22 may be formed through any suitable process. For example, the tubular support member 22 may be extruded, stamped, bent and/or folded to define the final shape of the tubular support member 22. Preferably, the tubular support member 22 is formed from a metal, including but not limited to steel or aluminum.

The method further includes overcasting the cast member 24 onto the tubular support member 22. The cast member 24 may be overcast onto the tubular support member 22 with any suitable casting process, including but not limited to a die casting process, a sand casting process, a precision sand casting process, a permanent mold casting process, or a lost-foam casting process. The cast member 24 is overcast around an outer periphery 46 of the tubular support member 22 such that the cast member 24 is overcast in interlocking engagement with the undulations 34 in the tubular support member 22. As such, the interlocking engagement between the cast member 24 and the undulations 34 in the tubular support member 22 rotationally fix the cast member 24 relative to the tubular support member 22. Additionally, the undulations 34 increase the strength of the tubular support member 22 to better resist localized depressions and/or indentations in the tubular support member 22 that may occur during the overcasting process.

Overcasting the cast member 24 around the outer periphery 46 of the tubular support member 22 includes positioning the formed tubular support member 22 in a mold. The mold defines a shape of the cast member 24. For example, the mold may define the shape of the cast member 24 to extend outward away from the tubular support member 22 to a cantilevered distal end 48. Due to the interlocking engagement between the undulations 34 and the cast member 24, the cantilevered distal end 48 is restricted from rotation relative to the tubular support member 22. It should be appreciated that the mold may define any suitable and/or desirable shape for the cast member 24, and may further define multiple cast members 24.

Once the tubular support member 22 is positioned within the mold, a molten metal is injected into the mold around the outer periphery 46 of the tubular support member 22. Preferably, the molten metal includes magnesium. However, it should be appreciated that the molten metal may include some other metal, including but not limited to aluminum. After the molten metal is injected into the mold, the molten metal is cooled to form the cast member 24. The molten metal may be cooled in any suitable manner, dependent upon the specific casting process utilized.

The undulations 34 act as an accordion like device to allow radial contraction of the tubular support member 22. As such, the tubular support member 22 is radially compressible inward toward the longitudinal axis 36. During overcasting of the molten metal onto and around the outer periphery 46 of the tubular support member 22, the molten metal heats the tubular support member 22, thereby urging the tubular support member 22 to expand radially outward away from the longitudinal axis 36 and toward the cast member 24. As the molten metal cools, the cast member 24 contracts in opposition to the expansion of the tubular support member 22. However, the geometric configuration of the undulations 34 in the tubular support member 22 allow the tubular support member 22 to flex radially inward about and toward the longitudinal axis 36 while the molten metal cools to form the cast member 24, thereby preventing tearing and/or cracks in the cast metal. Similarly, during use of the support structure 20 in which the support structure 20 is subjected to repeated thermal expansion and contraction cycles, the undulations 34 allow the tubular support member 22 to flex radially inward toward the longitudinal axis 36, thereby preventing damage to the support structure 20 from the repeated expansion and contraction cycles. This is particularly beneficial when the tubular support member 22 and the cast member 24 are formed from different materials having different coefficients of thermal expansion.

While the best modes for carrying out the invention have been described in detail, those familiar with the art to which this invention relates will recognize various alternative designs and embodiments for practicing the invention within the scope of the appended claims.

1. A method of manufacturing a support structure, the method comprising:
forming a tubular support member to define a plurality of undulations extending longitudinally along a longitudinal axis of the tubular support member and angularly spaced about the longitudinal axis; and
overcasting a cast member around an outer periphery of the tubular support member such that the cast member is overcast in interlocking engagement with the plurality of undulations in the tubular support member.

2. A method as set forth in claim 1 wherein forming the tubular support member to define the plurality of undulations includes forming the tubular support member to define a cross section perpendicular to the longitudinal axis including a plurality of peaks alternating with a plurality of valleys.

3. A method as set forth in claim 2 wherein the plurality of peaks includes a pre-defined number of peaks, and wherein the plurality of valleys includes a pre-defined number of valleys.

4. A method as set forth in claim 3 wherein the number of peaks is equal to the number of valleys.

5. A method as set forth in claim 4 wherein the number of peaks and the number of valleys are each at least equal to or greater than three (3).

6. A method as set forth in claim 5 wherein the number of peaks and the number of valleys are each between the range of six (6) and ten (10).

7. A method as set forth in claim 2 wherein forming the tubular support member includes extruding the tubular support member.

8. A method as set forth in claim 2 wherein forming the tubular support member is further defined as forming the tubular support member from a metal.

9. A method as set forth in claim 1 wherein overcasting the cast member around the outer periphery of the tubular support member includes positioning the formed tubular support member in a mold defining a shape of the cast member.

10. A method as set forth in claim 9 wherein overcasting the cast member around the outer periphery of the tubular support member includes injecting a molten metal into the mold around the outer periphery of the tubular support member.

11. A method as set forth in claim 10 wherein the molten metal includes magnesium.

12. A method as set forth in claim 10 wherein overcasting the cast member around the outer periphery of the tubular support member includes cooling the molten metal to form the cast member, wherein the undulations in the tubular support member allow the tubular support member to flex radially inward about the longitudinal axis while the molten metal cools to form the cast member.

13. A method as set forth in claim 12 wherein the cast member is cantilevered from the tubular support member and rotationally fixed relative to the tubular support member.

14. A method as set forth in claim 1 wherein overcasting the cast member includes overcasting the cast member with one of a die casting process, a sand casting process, a precession sand casting process, a permanent mold casting process, or a lost-foam casting process.

15. A support structure comprising:
a tubular support member including a plurality of undulations extending along a longitudinal axis of the tubular support member and angularly spaced about the longitudinal axis, wherein the tubular support member is formed from a metal; and
a cast member cast about an outer periphery of the tubular support member in interlocking engagement with the plurality of undulations and extending transversely away from the longitudinal axis to a distal end;
wherein the cast member is overcast onto the tubular support member from a molten metal.

16. A support structure as set forth in claim 15 wherein tubular support member defines a cross section perpendicular to the longitudinal axis including a plurality of peaks alternating with a plurality of valleys.

17. A support structure as set forth in claim 15 wherein the plurality of peaks includes a pre-defined number of peaks and the plurality of valleys includes a pre-defined number of valleys, wherein the pre-defined number of peaks is equal to the pre-defined number of valleys.

18. A support structure as set forth in claim 17 wherein the pre-defined number of peaks and the pre-defined number of valleys is equal to or greater than three.

19. A support structure as set forth in claim 17 wherein the tubular support member is radially compressible inward toward the longitudinal axis.

20. A support structure comprising:
a tubular support member defining a cross section perpendicular to a longitudinal axis having a plurality of peaks alternating with a plurality of valleys to define a plurality of undulations, wherein the plurality of undulations extend along the longitudinal axis of the tubular support member and are angularly spaced about the longitudinal axis, and wherein the tubular support member is formed from a metal;
wherein the plurality of peaks includes a pre-defined number of peaks and the plurality of valleys includes a pre-defined number of valleys, with the pre-defined number of peaks equal to the pre-defined number of valleys; and
a cast member cast about an outer periphery of the tubular support member in interlocking engagement with the plurality of undulations and extending transversely away from the longitudinal axis to a distal end;
wherein the cast member is overcast onto the tubular support member from a molten metal; and
wherein the tubular support member is radially compressible inward toward the longitudinal axis.
